(19) United States
(12) Patent Application Publication
(10) Pub. No.: US 2005/0219414 A1
(43) Pub. Date: Oct. 6, 2005

(54) Television receiver and image output method

(75) Inventor: Chihiro Tsukinokizawa, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/079,214

(22) Filed: Mar. 15, 2005

(30) Foreign Application Priority Data
Mar. 31, 2004 (JP) 2004-102679

(51) Int. Cl. H04N 5/21

(52) U.S. Cl. 348/552; 348/625

(57) ABSTRACT

In the prior art, the problem exists that even where an image displayed on a television screen is printed by a video printer, an image having different levels of brightness, tone, sharpness and the like than the image displayed on the television screen is printed. In order to resolve this problem, in the present invention, a television receiver is used that includes a display unit, a printer unit, an image adjustment unit that inputs image data, performs predetermined image quality level adjustment to the image data and outputs to the display unit the image data obtained as a result of the level adjustment, and an operation unit that is externally operated and receives at least specifications of the image quality levels and an instruction that the image displayed on the display unit is to be printed. Where the operation unit receives an external image quality level specifications, the image adjustment unit executes level adjustment to bring the image quality levels to the specified levels, and where the operation unit receives an external instruction to print the image displayed on the display unit, the image adjustment unit outputs to the printer unit image data identical to the image data output to the display unit and the printer unit prints the image expressed by the image data input from the image adjustment unit.

### BACKGROUND OF THE INVENTION

1. Field of the Invention

The present invention relates to a television receiver that includes a printer, and more particularly to a technology by which, where an image displayed on a television screen is to be printed, the levels of brightness, tone, sharpness and the like of the printed image are made approximately equal to the levels for the image displayed on the television screen.

2. Description of the Related Art

The capability to print images displayed on a television screen has been sought. In response to this demand, video printers that perform printing by inputting video signals from the output terminal of a television receiver and capturing and printing the desired image have been commercialized.

An example of this type of video printer is disclosed in Japanese Patent Laid-Open Gazettes No. 10-181103, for example.

FIG. 5 is an explanatory drawing showing the basic construction of a video printer and television receiver of the prior art described above. As shown in FIG. 5, the television receiver Tr comprises mainly an antenna ANT, a tuner unit 10, a signal converter 11, an image processor 12, an image display unit 13, an operation unit 14, and an external output interface 15. Here, the operation unit 14 includes adjust buttons not shown.

The video printer Vp, on the other hand, comprises mainly a signal converter 20, an image processor 21, a printer engine 22 and an operation unit 23. The operation unit 23 includes adjust buttons and a print button not shown.

The signal converter 20 of the video printer Vp and the external output interface 15 of the television receiver Tr are connected to each other via a cable.

In the television receiver Tr, the antenna ANT outputs received television broadcast signals to the tuner unit 10. The tuner unit 10 tunes the input television broadcast signals and, following signal demodulation, distributes them to the external output interface 15 and the signal converter 11. The external output interface 15 outputs the input signals to the signal converter 20 of the video printer Vp. At the same time, the signal converter 11 performs desired signal conversion of the input signals and outputs the converted signals to the image processor 12. The image processor 12 adjusts the levels of the brightness, tone, sharpness and the like of the input broadcast signals and outputs the adjusted signals to the image display unit 13. Based on the input signals, the image display unit 13 then displays the image expressed by these signals.

Here, the user of the television receiver Tr can adjust the brightness, tone, sharpness and the like of the images displayed on the image display unit 13 to a desired level by operating the adjust buttons of the operation unit 14. The operation unit 14 generates data indicating the levels of the user-adjusted brightness, tone, sharpness and similar parameters (hereinafter termed ‘level data’), and sends this data to the image processor 12. The image processor 12 then carries out the level adjustment described above such that the corresponding levels match the levels expressed by the received level data.

At the same time, in the video printer Vp, the signal converter 20 carries out desired signal conversion to the signals input from the external output interface 15 of the television receiver Tr and outputs the converted signals to the image processor 21. When the print button of the operation unit 23 is then pressed by the user of the video printer Vp, the image processor 21 carries out level adjustment to the signals from the signal converter 20 for the brightness, tone, sharpness and the like, converts the adjusted signals into image data in a format that can be handled by the printer engine 22, and transmits the image data to the printer engine 22. The printer engine 22 then prints the image based on the received image data.

The user of the video printer Vp can adjust the brightness, tone, sharpness and the like of an image to be printed by the printer engine 22 to the desired level by operating the adjust buttons of the operation unit 23. The operation unit 23 generates level data regarding the user-adjusted brightness, tone, sharpness and the like and sends it to the image processor 21. The image processor 21 then carries out the level adjustment described above to adjust the levels of the various parameters for the received level data.

As described above, in the prior art, the images displayed on the television screen undergo level adjustment regarding the brightness, tone, sharpness and the like separately from the images printed by the video printer. Therefore, even where an image displayed on the television screen is printed using the video printer, the problem exists that the printed image has different levels of brightness, tone, sharpness and the like from the image displayed on the television screen.

### SUMMARY OF THE INVENTION

The present invention was devised in order to resolve the above problem with the prior art technique, and an object thereof is, where an image displayed on a television screen is to be printed, to enable the levels of brightness, tone, sharpness and the like of the printed image to be almost identical to the levels for the image displayed on the television screen.

In order to attain at least part of the above and the other related objects, the present invention is directed to a first television receiver. The first television receiver includes: a display unit that displays at least images; a printer unit that prints at least images; an image adjustment unit that inputs image data expressing an image, performs predetermined image quality level adjustment to the image data and outputs to the display unit the image data obtained as a result of the level adjustment; and an operation unit that is externally operated and receives at least specifications of the image quality levels and an instruction that the image displayed on the display unit is to be printed, wherein where the operation unit receives an external image quality level specifications, the image adjustment unit executes level adjustment to bring the image quality levels to the specified levels, and where the operation unit receives an external instruction to print the image displayed on the display unit, the image adjustment unit outputs to the printer unit image data identical to the image data output to the display unit and the printer unit prints the image expressed by the image data input from the image adjustment unit.

Using this construction, when the user operates the operation unit to specify desired image quality levels for an image displayed on the display unit, the image adjustment unit carries out level adjustment to the input image data so that the image quality levels will match the levels specified by the user, and outputs the level-adjusted image data to the display unit. Therefore, the quality of the image displayed on the display unit reflects the user's preferred levels.

When the user operates the operation unit to instruct that the image displayed on the display unit be printed by the printer unit, because the image adjustment unit outputs to the printer unit image data identical to the image data output to the display unit, the printer unit can print an image identical to that displayed on the display unit such that the image quality levels are essentially the same.

The present invention is also directed to a second television receiver. The second television receiver includes a display unit that displays at least images; a printer unit that prints at least images; a first image adjustment unit that inputs image data expressing an image, performs predetermined image quality level adjustment to the image data and outputs to the display unit the image data obtained as a result of the level adjustment; a second image adjustment unit that inputs the image data, executes the image quality level adjustment to the image data and outputs to the printer unit the image data obtained as a result of the level adjustment; and an operation unit that is externally operated and receives at least the image quality level specifications and an instruction that the image displayed on the display unit is to be printed, wherein where the operation unit receives the external image quality level specifications, the first image adjustment unit executes level adjustment to bring the image quality levels to the specified levels, and where the operation unit receives an external instruction to print the image displayed on the display unit, the second image adjustment unit executes level adjustment to bring the image quality levels to the levels attained via the adjustment by the first image adjustment unit and outputs to the printer unit the image data obtained as a result of the level adjustment, and the printer unit prints the image expressed by the image data input from the second image adjustment unit.

By virtue of this construction, when the user operates the operation unit to specify predetermined image quality levels for an image displayed on the display unit, the image adjustment unit executes level adjustment to the input image data to bring the image quality levels to the levels specified by the user and outputs to the display unit the level-adjusted image data. Therefore, the quality of the image displayed on the display unit reflects the user's preferred levels.

When the user then operates the operation unit to instruct that the image displayed on the display unit be printed by the printer unit, the second image adjustment unit executes level adjustment to the input image data to bring the image quality levels to the levels attained via the adjustment by the first image adjustment unit. Therefore, the image quality of the image expressed by the image data after this level adjustment reflects the same parameter levels as the image expressed by the image data output to the display unit by the first image adjustment unit. Because the second image adjustment unit then outputs to the printer unit this level-adjusted image data, the printer unit can print an image identical to that displayed on the display unit such that the image quality [parameter] levels are essentially the same.

The above predetermined image quality may consist of at least one of brightness, tone and sharpness. Brightness, tone and sharpness are representative parameters of image quality that may be adjusted by the user.

The present invention may also be realized as a method for outputting to a printer unit image data identical to the image displayed on a display unit in a television receiver that includes the display unit that displays at least images and the printer unit that prints at least images.

### BRIEF DESCRIPTION OF THE DRAWINGS

FIG. 1 is an explanatory drawing showing the basic construction of the television receiver of a first embodiment;

FIG. 2 is a flow chart showing the sequence of operations for printing of an image displayed on the screen in the first embodiment;

FIG. 3 is an explanatory drawing showing the basic construction of the television receiver of a second embodiment;

FIG. 4 is a flow chart showing the sequence of operations for printing of an image displayed on the screen in the second embodiment; and

FIG. 5 is an explanatory drawing showing the basic construction of the video printer and television receiver of the prior art.

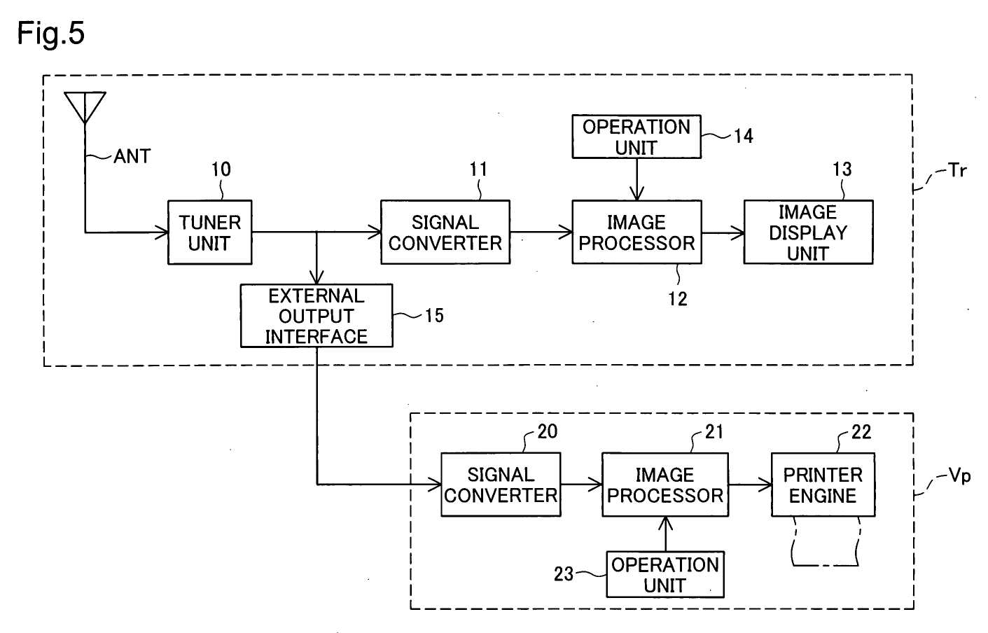

### DESCRIPTION OF THE PREFERRED EMBODIMENTS

The preferred embodiments by which the present invention is realized are described below in the following sequence.

A. First Embodiment

A1. Apparatus Construction and General Operation

A2. Printing routine

A3. Effect of first embodiment

B. Second Embodiment

B1. Apparatus construction and general operation

B2. Printing routine

B3. Effect of first embodiment

C. Variations

C1. Variation 1-C6. Variation 6

A. First Embodiment

A1. Apparatus Construction and General Operation

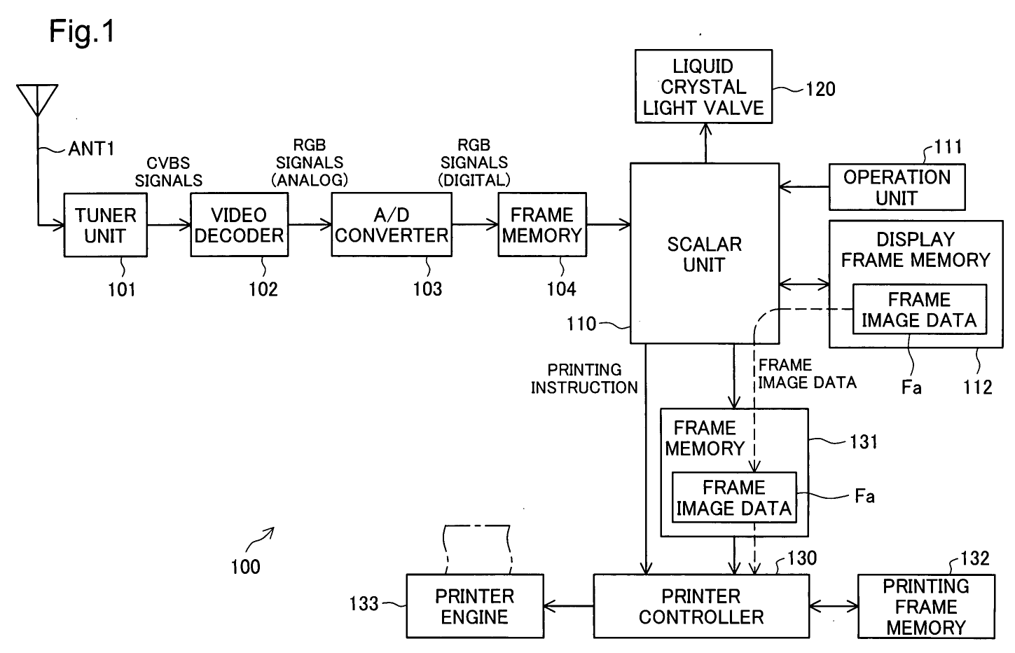

FIG. 1 is an explanatory drawing showing the basic construction of the television receiver of a first embodiment of the present invention. This television receiver 100 is a rear-projection type television receiver, and as described below, it displays images by projecting light that expresses an image (hereinafter ‘image light’) onto a screen (not shown) disposed on the front surface of the television receiver 100. In FIG. 1, the optical system of the rear projector is not shown.

The television receiver 100 includes as components that function as television receiver components mainly an antenna ANT1, a tuner unit 101, a video decoder 102, an A/D converter 103, a frame memory 104, a scalar unit 110, an operation unit 111, a display frame memory 112, and a liquid crystal light valve 120, and includes as components that function as printer components mainly a printer controller 130, a frame memory 131, a printing frame memory 132 and a printer engine 133. These constituent elements are controlled by a CPU (not shown). In this embodiment, the television receiver 100 is constructed such that the television receiver components and the printer components are integrated as a single unit.

The operation unit 111 includes adjust buttons and a print button not shown. The printer engine 133 comprises a group of hardware components that carry out printing onto paper such as thermal heads (not shown). The frame memory 104, the display frame memory 112, the frame memory 131 and the printing frame memory 132 can each store frame image data for one frame.

The liquid crystal light valve 120 is a transmissive liquid crystal light valve that incorporates a number of liquid crystal cells (not shown).

The scalar unit 110 includes an internal RAM (not shown), and level data regarding the brightness, tone and sharpness of the image displayed on the screen is stored in this RAM. In the initial state, predetermined level data is stored in the RAM as default values.

The general operation of the television receiver 100 will now be described.

In the television receiver 100, the antenna ANT1 outputs received television broadcast signals to the tuner unit 101. The tuner unit 101 tunes the input television broadcast signals and demodulates them, thereby obtaining CVBS signals comprising brightness signals, color signals (color subcarrier) and synchronization signals, and outputs these CVBS signals to the video decoder 102. When a CVBS signal is input, the video decoder 102 separates the brightness signal and the color signal, converts the color signal to an analog RGB signal, and outputs the analog RGB signal to the A/D converter 103. The A/D converter 103 converts the input analog RGB signal into a digital RGB signal and outputs it to the frame memory 104. When this digital RGB signal is input, the frame memory 104 sequentially overwrites and stores the signal for one frame (frame image data).

The scalar unit 110 sequentially retrieves the frame image data stored in the frame memory 104 and converts the resolution of the image expressed by the frame image data via interpolation in order to harmonize it with the resolution of the liquid crystal light valve 120. The scalar unit 110 then adjusts the brightness, tone and sharpness levels for the resolution-converted frame image data. This level adjustment operation is described in detail below.

The scalar unit then sequentially overwrites the level-adjusted frame image data and stores it in the display frame memory 112 and thereafter sequentially retrieves the frame image data stored in this display frame memory 112 and outputs it to the liquid crystal light valve 120.

When the frame image data is input from the scalar unit 110, the liquid crystal light valve 120 emits the image light for the image expressed by the frame image data toward the projection optical system (not shown) by changing the arrangement of the liquid crystal molecules contained in the liquid crystal cells (not shown) to either pass through or block the incident light introduced via the illumination optical system (not shown). When the image light is received from the liquid crystal light valve, this projection optical system projects the image light toward the screen (not shown).

In this way, images expressing the frame image data are sequentially displayed on the screen.

The operation of the television receiver 100 when the user adjusts the brightness, tone and sharpness levels for the images displayed on the screen will now be described.

When the user operates the adjust buttons of the operation unit 111 to adjust the brightness, tone and sharpness of the images displayed on the screen to desired levels, the operation unit 111 generates new level data indicating the user adjusted levels and transmits this data to the scalar unit 110.

When the newly-generated level data is received, the scalar unit 110 stores it in its internal RAM. Also stored in this RAM are the initial level values or old level data generated during the previous level adjustment. The scalar unit 110 overwrites the initial values or the old level data by storing the newly-generated level data in the RAM.

Because the scalar unit 110 then retrieves the newly-generated level data from the RAM and adjusts the brightness, tone and sharpness levels of the image data to match the levels expressed by the level data, the brightness, tone and sharpness levels for the image displayed on the screen are adjusted to the levels desired by the user.

A2. Printing Routine

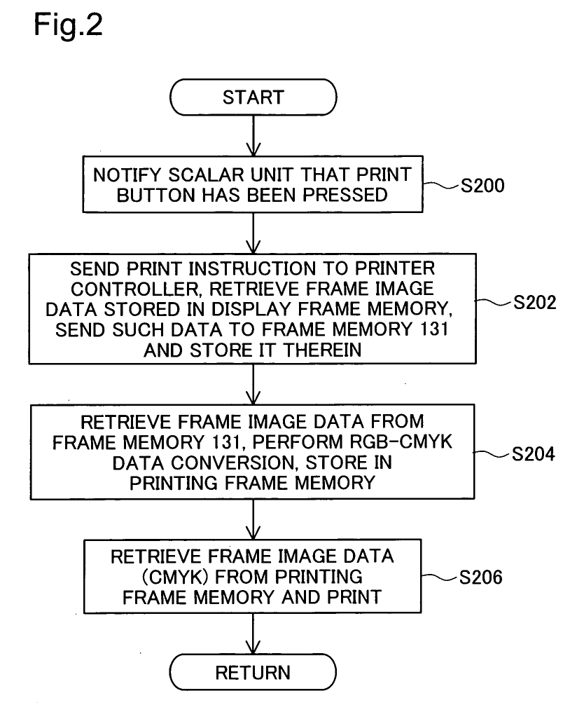

FIG. 2 is a flow chart showing the sequence of operations of the routine by which an image displayed on the screen is printed in the first embodiment of the present invention.

Here, it is assumed that images are displayed on the screen of the television receiver 100 and the user of the television receiver 100 has pressed the print button of the operation unit 111 to instruct the television receiver 100 to commence printing in order to print a certain displayed image.

First, the operation unit 111 notifies the scalar unit 110 that the print button has been pressed (step S200). When the notification that the print button was pressed is received, the scalar unit 110 sends a print instruction to the printer controller 130, retrieves the frame image data Fa stored in the display frame memory 112 and forwards this data to the frame memory and stores it therein (step S202).

When the print instruction is received from the scalar unit 110, the printer controller 130 retrieves the frame image data Fa stored by the scalar unit 110 in the frame memory 131, converts this data into frame image data comprising the colors CMYK (cyan, magenta, yellow and black) that can be processed by the printer engine 133, and stores the converted data in the printing frame memory 132 (step S204).

Next, the printer controller 130 retrieves the frame image data stored in the printing frame memory 132 and sends it to the printer engine 133, and the printer engine 133 prints the image based on this fame image data (step S206).

A3. Effect of First Embodiment

As described above, the scalar unit 110 outputs to the liquid crystal light valve 120 the level-adjusted frame image data stored in the display frame memory 112 and when printing is instructed by the user of the television receiver 100, the scalar unit 110 forwards the level-adjusted frame data that had been output to the liquid crystal light valve 120 to the frame memory 131 as well. The image expressed by the frame image data output to the liquid crystal light valve 120 is displayed on the screen, while the image expressed by the frame image data forwarded to the frame memory 131 is printed by the printer engine 133.

Therefore, where the image displayed on the screen is to be printed by the printer engine 133, the levels of brightness, tone, sharpness and the like of the printed image can be made essentially identical to the levels for the image displayed on the screen.

B. Second Embodiment

B1. Apparatus Construction and General Operation

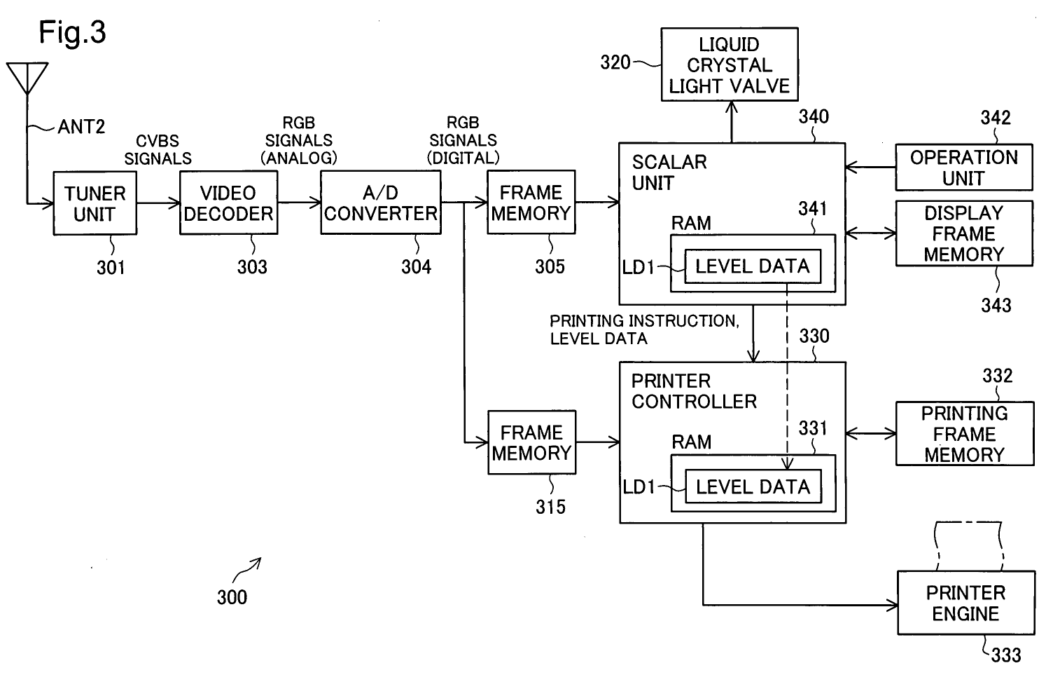

FIG. 3 is an explanatory drawing showing the basic construction of the television receiver of a second embodiment of the present invention. This television receiver 300, like the television receiver 100 shown in FIG. 1, is a rear-projection type television receiver, and displays images by projecting image light onto a screen (not shown) disposed on the front surface of the television receiver 300. In FIG. 3 as well, the rear-projection optical system is omitted from the drawing.

In addition to an antenna ANT2, a tuner unit 301, a video decoder 303 and an A/D converter 304, the television receiver 300 includes as components that function as television receiver components mainly a frame memory 305, a scalar unit 340, an operation unit 342, a display frame memory 343 and a liquid crystal light valve 320, and includes as components that function as printer components mainly a frame memory 332, a printer controller 330, a printing frame memory 332 and a printer engine 333. These constituent elements are controlled by a CPU (not shown). In this embodiment, the television receiver 300 is constructed such that the television receiver components and the printer components are integrated as a single unit.

The scalar unit 340 of this embodiment, like the scalar unit 110 of the first embodiment described above, includes an internal RAM (not shown) and stores level data. At the same time, the printer controller 330 of this embodiment, unlike the printer controller 130 of the first embodiment, includes an internal RAM 331 that stores level data, and as described below, performs level adjustment to the brightness, tone and sharpness so that such levels match the levels expressed by the level data stored in this RAM 331.

In the initial state, identical sets of predetermined level data are stored as default values in the RAM 341 and the RAM 331.

Because the frame memories 305 and 315, the display frame memory 343, the printing frame memory 332, the operation unit 342, the liquid crystal light valve 320 and the printer engine 333 have the same construction as the frame memory 104, the display frame memory 112, the printing frame memory 132, the operation unit 111, the liquid crystal light valve 120 and the printer engine 133 of the first embodiment described above, respectively, further description thereof will be omitted.

The general operation of the television receiver 300 will now be described.

The operations executed by the television receiver 300 from the time that the antenna ANT2 receives a television broadcast signal to the time that an image is displayed on the screen (not shown) are identical to the corresponding operations carried out by the television receiver 100 of the first embodiment described above, and will therefore not be described herein.

However, the A/D converter 304 shown in FIG. 3 differs from the A/D converter 103 shown in FIG. 1 in that after it converts the analog RGB signal into a digital RGB signal, it outputs the converted digital RGB signal to the frame memory 305 and also outputs it to the frame memory 315 as well. When the digital RGB signal is input, the frame memory 315, like the frame memory 305, stores it until signals for one frame (frame image data) are stored via sequential overwriting. The frame image data stored by this frame memory 315 is not input to the printer controller 330 unless it is retrieved by the printer controller 330, as described below.

Because the operations of the television receiver 300 where the user of the television receiver 300 adjusts the levels of brightness, tone and sharpness of the image displayed on the screen are identical to the operations of the television receiver 100 described above, they are not described here. However, as a result of the level adjustment, the operation unit 342 generates new level data LD1 and the scalar unit 340 is caused to store this level data LD1 in the RAM 341 incorporated therein.

B2. Printing Routine

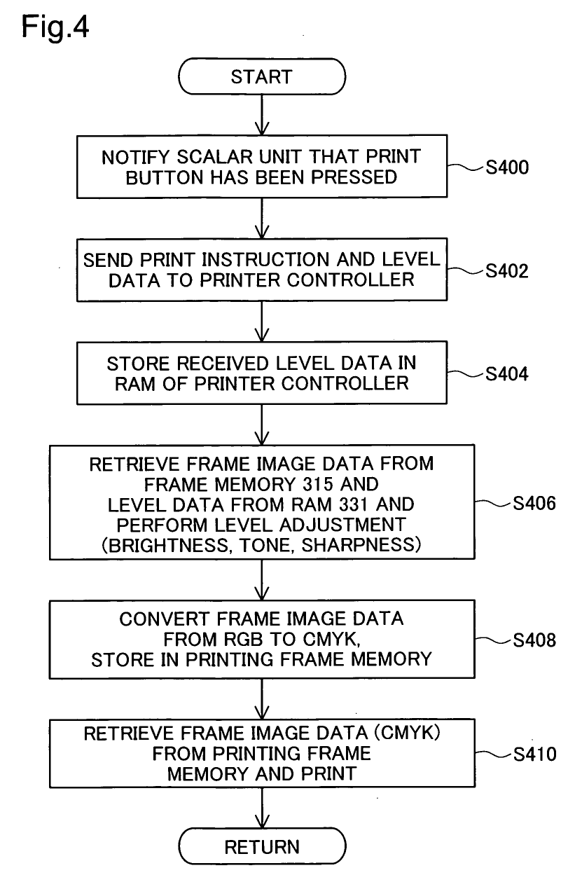

FIG. 4 is a flow chart showing the sequence of operations of the routine by which an image displayed on the screen is printed in the second embodiment of the present invention.

Here, it is assumed that images are displayed on the screen of the television receiver 300 and the user of the television receiver 300 has pressed the print button of the operation unit 342 to instruct the television receiver 100 to commence printing in order to print a certain displayed image.

First, the operation unit 342 notifies the scalar unit 340 that the print button has been pressed (step S400). When the print button notification is received, the scalar unit 340 sends a print instruction to the printer controller 330 together with the level data LD1 stored in the RAM 341 (step S402).

When the above print instruction and level data LD1 are received, the printer controller 330 first stores the level data LD1 in the RAM 331 incorporated therein (step S404). Initial values or previously received level data are stored in this RAM 331, and are overwritten by the level data LD1 stored by the printer controller 330 in the RAM 331.

Next, the printer controller 330 retrieves the frame image data stored in the frame memory 315 and the level data LD1 stored in the RAM 331, and adjusts the levels of brightness, tone and sharpness of the retrieved frame image data to match the levels in the level data LD1 (step S406).

The printer controller 330 then converts the level-adjusted frame data to frame image data composed of the colors CMYK that can be processed by the printer engine 333 and stores the converted data in the printing frame memory 332 (step S408).

The printer controller 330 then retrieves the frame image data stored in the printing frame memory 332 and sends it to the printer engine 333, which prints the image based on this frame image data (step S410).

B3. Effect of Second Embodiment

As described above, when a print instruction is received from the scalar unit 340, the printer controller 330 retrieves from the frame memory 315 frame image data identical to that retrieved from the frame memory 305 by the scalar unit 340 and retrieves from the RAM 331 level data LD1 identical to that retrieved from the RAM 341 by the scalar unit 340, and adjusts the brightness, tone and sharpness levels for the above retrieved frame image data to match the levels of the level data LD1.

Therefore, the image expressed by the frame image data sent to the printer engine 333 by the printer controller 330 following level adjustment has the same brightness, tone and sharpness as the image expressed by the frame image data output by the scalar unit 340 to the liquid crystal light valve 120 following level adjustment.

Consequently, where an image displayed on the screen is to be printed by the printer engine 333, the brightness, tone and sharpness levels for the image to be printed can be matched to the levels for the image displayed on the screen.

B3. Variations

The above embodiments and their applications are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

C1. Variation 1

In the second embodiment described above, after the user presses the print button of the operation unit 342 and the operation unit 342 notifies the scalar unit 340 that the print button was pressed, the scalar unit 340 sends the level data LD1 stored in the RAM 341 to the printer controller 330. The present invention is not limited to this implementation, however, and it is acceptable if after the user operates the adjust buttons of the operation unit 342 to adjust the brightness, tone and sharpness of the image displayed on the screen and the operation unit 342 sends newly-generated level data to the scalar unit 340, the scalar unit 340 sends this level data to the printer controller 330.

C2. Variation 2

The television receiver 100 of the first embodiment and the television receiver 300 of the second embodiment are both rear-projection type television receivers, but a liquid crystal display or a CRT display may be used instead.

Furthermore, the printer engine 133 of the first embodiment and the printer engine 333 of the second embodiment each comprise a group of hardware components such as thermal heads, but they may instead comprise a group of other hardware components used for printing onto paper, such as a photoreceptor drum, inkjet heads or ink ribbons.

C3. Variation 3

In the first embodiment described above, the video decoder 102 converted the CVBS signal into an analog RGB signal and the A/D converter 103 then converted this analog RGB signal into a digital RGB signal, but it is acceptable if (1) the order of operations carried out by the video decoder 102 and the A/D converter 103 is reversed, (2) the video decoder decodes digital signals instead of CVBS signals, and (3) the A/D converter 103 converts the CVBS signal into a digital CVBS signal and the video decoder then outputs a digital RGB signal based on this digital CVBS signal. Because this variation can be applied to the second embodiment in the same manner, such application will not be further described herein.

C4. Variation 4

In the first embodiment, the adjustment unit 111 generated level data, but it may alternatively generate, instead of level data, information indicating the amounts by which the brightness, tone and sharpness levels are to be adjusted (i.e., pre- and post-adjustment level differences). In this case, the scalar unit 110 may change the level data stored in the RAM based on the information indicating these level adjustment amounts received from the operation unit 111. Because this variation can be applied to the second embodiment in the same manner, such application will not be further described herein.

C5. Variation 5

In the first embodiment, the television receiver 100 integrated as a single unit components that collectively functioned as a television receiver and components that collectively functioned as a printer, but a construction in which these components are separate rather than integrated as a single unit may be adopted.

C6. Variation 6

In the above embodiments, an image obtained via the receipt of television broadcast signals was printed, but it is acceptable if an image obtained from image signals output from a video player or DVD player, for example, is printed.

1. A television receiver comprising:
a display unit that displays at least images;
a printer unit that prints at least images;
an image adjustment unit that inputs image data expressing an image, performs predetermined image quality level adjustment to the image data and outputs to the display unit the image data obtained as a result of the level adjustment; and
an operation unit that is externally operated and receives at least specifications of the image quality levels and an instruction that the image displayed on the display unit is to be printed,
wherein where the operation unit receives an external image quality level specifications, the image adjustment unit executes level adjustment to bring the image quality levels to the specified levels, and
where the operation unit receives an external instruction to print the image displayed on the display unit, the image adjustment unit outputs to the printer unit image data identical to the image data output to the display unit and the printer unit prints the image expressed by the image data input from the image adjustment unit.

2. A television receiver including:
a display unit that displays at least images;
a printer unit that prints at least images;
a first image adjustment unit that inputs image data expressing an image, performs predetermined image quality level adjustment to the image data and outputs to the display unit the image data obtained as a result of the level adjustment;
a second image adjustment unit that inputs the image data, executes the image quality level adjustment to the image data and outputs to the printer unit the image data obtained as a result of the level adjustment; and
an operation unit that is externally operated and receives at least the image quality level specifications and an instruction that the image displayed on the display unit is to be printed,
wherein where the operation unit receives the external image quality level specifications, the first image adjustment unit executes level adjustment to bring the image quality levels to the specified levels, and
where the operation unit receives an external instruction to print the image displayed on the display unit, the second image adjustment unit executes level adjustment to bring the image quality levels to the levels attained via the adjustment by the first image adjustment unit and outputs to the printer unit the image data obtained as a result of the level adjustment, and the printer unit prints the image expressed by the image data input from the second image adjustment unit.

3. The television receiver according to claim 1, wherein the predetermined image quality include at least one of the parameters of brightness, tone and sharpness.

4. The television receiver according to claim 2, wherein the predetermined image quality include at least one of the parameters of brightness, tone and sharpness.

5. A method for outputting to a printer unit image data identical to the image displayed on a display unit in a television receiver that includes the display unit that displays at least images and the printer unit that prints at least images, the method comprising the steps of:
(a) outputting prepared image data to the display unit and causing the display unit to display the image;
(b) where predetermined image quality level specifications are received from an external source, performing level adjustment to the image data to be output to the display unit such that the quality levels of the image match the specified levels; and
(c) where an external instruction to perform printing of the image displayed on the display unit is received, outputting to the printer unit image data identical to that output to the display unit.

6. A method for outputting to a printer unit image data identical to the image displayed on a display unit in a television receiver that includes the display unit that displays at least images and the printer unit that prints at least images, the method comprising the steps of:
(a) outputting prepared image data to the display unit and causing the display unit to display the image;
(b) where predetermined image quality level specifications are received from an external source, performing level adjustment to the image data to be output to the display unit such that the quality levels of the image match the specified levels; and
(c) where an external instruction to perform printing of the image displayed on the display unit is received, performing level adjustment to the prepared image data such that the quality levels of the image match the levels attained via the adjustment in step (b) and outputting the data to the printer unit.
